(19) United States
(12) Patent Application Publication
(10) Pub. No.: US 2008/0253285 A1
(43) Pub. Date: Oct. 16, 2008

(54) Apparatus, method, and computer program product providing improved silence suppression detection

(75) Inventor: Jani Lakkakorpi, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/786,694

(22) Filed: Apr. 12, 2007

(51) Int. Cl. H04L 1/00

(52) U.S. Cl. 370/230

(57) ABSTRACT

Apparatus, methods and computer program products provide improved silence suppression detection that may be utilized, for example, in conjunction with an extended real-time polling service (ertPS) in a worldwide interoperability for microwave access (WiMAX, IEEE 802.16 standard) system. In one non-limiting, exemplary embodiment, a method includes: in response to receiving an uplink frame, setting or resetting a connection-specific timer; and in response to the connection-specific timer expiring, detecting a silence suppression interval and allocating a minimum amount of periodic resources for the associated connection.

### TECHNICAL FIELD

The exemplary embodiments of this invention relate generally to wireless communication systems and, more specifically, relate to silence suppression detection.

### BACKGROUND

The following abbreviations are utilized herein:

BE best effort

BS base station

ertPS extended real-time polling service

IEEE institute of electrical and electronics engineers

IP internet protocol

nrtPS non-real-time polling service

OFDMA orthogonal frequency division multiple access

QoS quality of service

rtPS realtime polling service

SS subscriber station

UGS unsolicited grant service

UE user equipment, such as a mobile station or mobile terminal

UL uplink (UE to BS)

VoIP voice over internet protocol

WiMAX worldwide interoperability for microwave access (IEEE 802.16 standard)

Reference with regard to WiMAX may be made to: IEEE Std 802.16e™-2005 and IEEE Std 802.16™-2004/Cor1-2005, “IEEE Standard for Local and metropolitan area networks; Part 16: Air Interface for Fixed and Mobile Broadband Wireless Access Systems; Amendment 2: Physical and Medium Access Control Layers for Combined Fixed and Mobile Operation in Licensed Bands and Corrigendum 1,” incorporated by reference herein in its entirety.

WiMAX supports five QoS classes, namely: UGS, rtPS, ertPS, nrtPS and BE. See, e.g., IEEE Std 802.16e™ §§6.3.5.2 and 6.3.20. ertPS is primarily intended for VoIP with silence suppression. In ertPS, the SS are periodically polled. That is, the SSs are granted slots that can be used for sending UL data and for requesting more slots.

As stated in IEEE Std 802.16e™ §6.3.5.2.2.1: “Extended rtPS is a scheduling mechanism which builds on the efficiency of both UGS and rtPS. The BS shall provide unicast grants in an unsolicited manner like in UGS, thus saving the latency of a bandwidth request. However, whereas UGS allocations are fixed in size, ertPS allocations are dynamic. The Extended rtPS is designed to support real-time service flows that generate variable size data packets on a periodic basis, such as Voice over IP services with silence suppression.”

Utilizing ertPS, the number of periodically granted slots is not constant and can be modified according to current bandwidth needs, for example. Furthermore, ertPS connections can participate in contention in order to obtain slots.

### SUMMARY

In an exemplary aspect of the invention, a method includes: in response to receiving an uplink frame, setting or resetting a connection-specific timer; and in response to the connection-specific timer expiring, detecting a silence suppression interval and allocating a minimum amount of periodic resources for the associated connection.

In another exemplary aspect of the invention, a computer program product includes program instructions embodied on a tangible computer-readable medium. Execution of the program instructions results in operations including: in response to receiving an uplink frame, setting or resetting a connection-specific timer; and in response to the connection-specific timer expiring, detecting a silence suppression interval and allocating a minimum amount of periodic resources for the associated connection.

In a further exemplary aspect of the invention, an electronic device includes: a receiver; at least one connection-specific timer configured, in response to the receiver receiving an uplink frame, to set or reset; and a data processor configured, in response to the at least one connection-specific timer expiring, to detect a silence suppression interval and allocate a minimum amount of periodic resources for the associated connection.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 illustrates a simplified block diagram of an electronic device that is suitable for use in practicing the exemplary embodiments of this invention; and

FIG. 2 depicts a flowchart illustrating one non-limiting example of a method for practicing the exemplary embodiments of this invention.

### DETAILED DESCRIPTION

In conventional systems, the SS detects when silence suppression is applied. Additional fields in the management messages between the SS and the BS are used to signal the BS. The mobile station may request changing the size of the UL allocation by using an extended piggyback request field of the Grant Management subheader, using a bandwidth request (BR) field of the medium access control (MAC) signaling headers (as described in Table 5a of IEEE Std 802.16e™) or sending a codeword (defined in IEEE Std 802.16e™ §8.4.5.4.10.13) over the channel quality information channel (CQICH). See IEEE Std 802.16e™. §6.3.5.2.2.1.

Utilizing aspects of the exemplary embodiments of the invention, instead of letting the SS detect when silence suppression is used, the BS starts a connection-specific timer whenever an UL frame is received. When the timer expires, the minimum value is used in the periodic grants for the connection. That is, only the number of slots needed for sending a bandwidth request are granted for the connection.

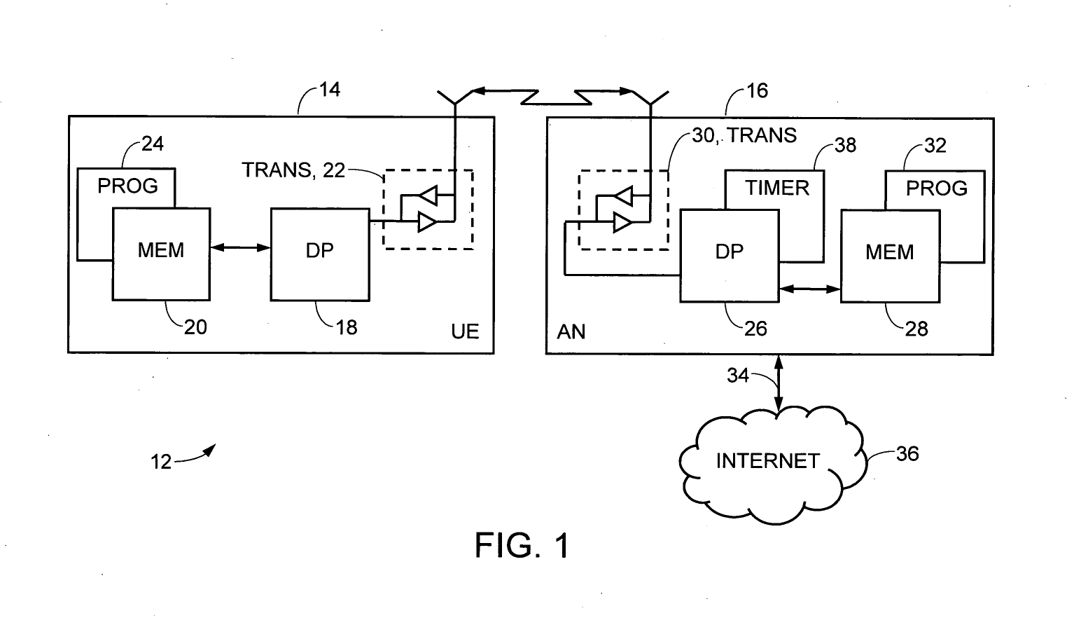

Reference is made to FIG. 1 for illustrating a simplified block diagram of various electronic devices that are suitable for use in practicing the exemplary embodiments of this invention. In FIG. 1, a wireless network 12 is adapted for communication with a user equipment (UE) 14 via an access node (AN) 16. The UE 14 includes a data processor (DP) 18, a memory (MEM) 20 coupled to the DP 18, and a suitable RF transceiver (TRANS) 22 (having a transmitter (TX) and a receiver (RX)) coupled to the DP 18. The MEM 20 stores a program (PROG) 24. The TRANS 22 is for bidirectional wireless communications with the AN 16. Note that the TRANS 22 has at least one antenna to facilitate communication.

The AN 16 includes a data processor (DP) 26, a memory (MEM) 28 coupled to the DP 26, at least one connection-specific timer (TIMER) 38 coupled to the DP 26, and a suitable RF transceiver (TRANS) 30 (having a transmitter (TX) and a receiver (RX)) coupled to the DP 26. The MEM 28 stores a program (PROG) 32. The TRANS 30 is for bidirectional wireless communications with the UE 14. Note that the TRANS 30 has at least one antenna to facilitate communication. The AN 16 is coupled via a data path 34 to one or more external networks or systems, such as the internet 36, for example.

At least one of the PROGs 24, 32 is assumed to include program instructions that, when executed by the associated DP, enable the electronic device to operate in accordance with the exemplary embodiments of this invention, as discussed herein.

In general, the various embodiments of the UE 14 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 18, 26 of the UE 14 and the AN 16, or by hardware, or by a combination of software and hardware.

The MEMs 20, 28 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 18, 26 may be of any type suitable to the local technical environment, and may include one or more of general purpose computers, special purpose computers, microprocessors, digital signal processors (DSPs) and processors based on a multi-core processor architecture, as non-limiting examples.

The TIMER 38 may comprise one or more hardware components, software components or a combination of hardware and software components. The TIMER 38 may be of any type suitable to the local technical environment. As non-limiting examples, the TIMER 38 may comprise: software connection-specific timer functionalities built into and executed by the associated DP 26, software connection-specific timer software stored in the MEM 28 and executed by the associated DP 26, a single hardware timer component that provides a separate connection-specific timer for each connection or separate hardware timer components that each provide a connection-specific timer for a single connection. The TIMER 38 incorporates functionality for a separate, connection-specific timer corresponding to each connection.

In one non-limiting, exemplary embodiment, the ertPS implementation comprises two states: an on-state (talkspurt) and an off-state (silence).

In the on-state, a specified number of slots is granted for each connection. The specified number of slots is selected such that in most cases (e.g., when the VoIP packet header is compressed) there is no need to ask for more slots using a piggybacked bandwidth request. Instead, the whole packet can be sent in a single OFDMA frame, for example. In some cases, there may be uncompressed or other larger frames. In such cases, more resources can be requested using the piggybacked bandwidth request.

In the off-state, the application does not send anything. Thus, the connection is granted only as many slots as are needed for sending a stand-alone bandwidth request.

The transition from the on-state to the off-state occurs utilizing the connection-specific timer 38, as described above. Generally, transition from the off-state to the on-state is trivial because whenever an UL frame is received at the BS, the timer 38 is reset, thus granting the specified number of slots (e.g., unless a request for additional slots has been received and acted on).

In another non-limiting, exemplary embodiment, the ertPS implementation is designed for VoIP with silence suppression.

Generally, ertPS can provide substantial bandwidth savings as compared to UGS (due to constant polling rate, there is more unused bandwidth during silence suppression) or rtPS (generally more overhead during talkspurts as connections have to request more slots). ertPS also generally results in better latency than rtPS.

Aspects of the exemplary embodiments of the invention do not have to rely on the SS detecting when silence suppression is used. Furthermore, there is no need for signaling said detection to the BS.

Exemplary embodiments of the invention are particularly advantageous for silence suppression detection. Utilizing aspects of the exemplary embodiments of the invention, a solution to general rate adaptation may not be provided.

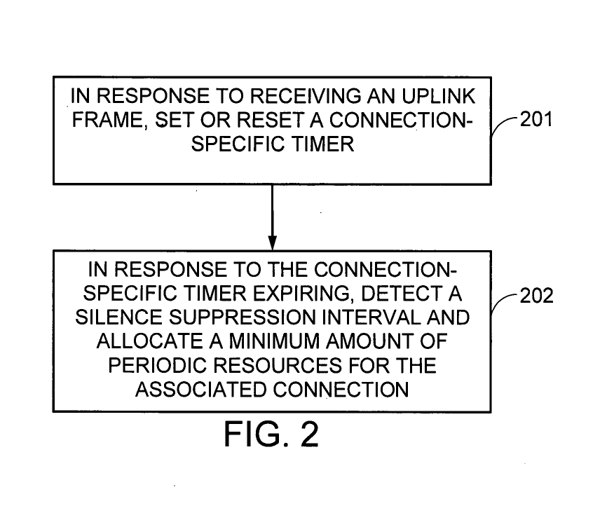

In one non-limiting, exemplary embodiment, and as shown in FIG. 2, a method comprises: in response to receiving an uplink frame, setting or resetting a connection-specific timer (box 201); and in response to the connection-specific timer expiring, detecting a silence suppression interval and allocating a minimum amount of periodic resources for the associated connection (box 202).

In another non-limiting, exemplary embodiment, the BS stores the current grant size when it decides to go into silence mode with the associated SS. In a further embodiment, when the SS “wakes up,” the connection resumes utilizing the grant size before the break. In another embodiment, when the SS “wakes up,” the connection resumes utilizing the grant size before the break unless the SS instructs otherwise.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

While the exemplary embodiments have been described above in the context of a WiMAX system, it should be appreciated that the exemplary embodiments of this invention are not limited for use with only this one particular type of wireless communication system, and that they may be used to advantage in other wireless communication systems.

Furthermore, while the exemplary embodiments have been described above in the context of ertPS, it should be appreciated that the exemplary embodiments of this invention are not limited for use with only this one particular type of QoS class, and that they may be used to advantage in other suitable systems utilizing other suitable QoS techniques (e.g., systems employing periodic polling with variable grants).

In addition, while the exemplary embodiments have been described above in the context of granting (e.g., allocating) a number of slots, it should be appreciated that the exemplary embodiments of this invention are not limited for use with only this one particular type of resource, and that they may be used to advantage with regards to other suitable types of resources, as appropriate to the system within which as aspects of the exemplary embodiments of the invention are employed.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method comprising:
in response to receiving an uplink frame, setting or resetting a connection-specific timer; and
in response to the connection-specific timer expiring, detecting a silence suppression interval and allocating a minimum amount of periodic resources for the associated connection.

2. The method of claim 1, further comprising:
in response to receiving an uplink frame, allocating a specified amount of resources.

3. The method of claim 2, wherein the specified amount of resources comprises a determined amount that fulfills requirements of a majority of connections.

4. The method of claim 2, wherein the specified amount is predefined by a service provider.

5. The method of claim 1, wherein the minimum amount of periodic resources comprises a minimum amount needed to send a request for additional resources.

6. The method of claim 5, wherein the request for additional resources comprises a bandwidth request message.

7. The method of claim 1, wherein the method is utilized within a worldwide interoperability for microwave access (WiMAX, IEEE 802.16 standard) system.

8. The method of claim 7, wherein the method is utilized in conjunction with an extended real-time polling service (ertPS).

9. The method of claim 8, wherein the method is utilized for connections comprising voice over internet protocol (VoIP) with silence suppression.

10. The method of claim 1, further comprising:
in response to detecting the silence suppression interval, storing a previous resource allocation of the associated connection.

11. The method of claim 10, further comprising:
in response to receiving an uplink frame from the associated connection after the silence suppression interval, utilizing the previous resource allocation for the associated connection.

12. A computer program product comprising program instructions embodied on a tangible computer-readable medium, execution of the program instructions resulting in operations comprising:
in response to receiving an uplink frame, setting or resetting a connection-specific timer; and
in response to the connection-specific timer expiring, detecting a silence suppression interval and allocating a minimum amount of periodic resources for the associated connection.

13. The computer program product of claim 12, execution of the program instructions resulting in operations further comprising:
in response to receiving an uplink frame, allocating a specified amount of resources.

14. The computer program product of claim 13, wherein the specified amount of resources comprises a determined amount that fulfills requirements of a majority of connections.

15. The computer program product of claim 13, wherein the specified amount is predefined by a service provider.

16. The computer program product of claim 12, wherein the minimum amount of periodic resources comprises a minimum amount needed to send a request for additional resources.

17. The computer program product of claim 16, wherein the request for additional resources comprises a bandwidth request message.

18. The computer program product of claim 12, wherein the method is utilized within a worldwide interoperability for microwave access (WiMAX, IEEE 802.16 standard) system.

19. The computer program product of claim 18, wherein the method is utilized in conjunction with an extended real-time polling service (ertPS).

20. The computer program product of claim 19, wherein the method is utilized for connections comprising voice over internet protocol (VoIP) with silence suppression.

21. The computer program product of claim 12, execution of the program instructions resulting in operations further comprising:
in response to detecting the silence suppression interval, storing a previous resource allocation of the associated connection.

22. The computer program product of claim 12, execution of the program instructions resulting in operations further comprising:
in response to receiving an uplink frame from the associated connection after the silence suppression interval, utilizing the previous resource allocation for the associated connection.

23. An electronic device comprising:
a receiver;
at least one connection-specific timer configured, in response to the receiver receiving an uplink frame, to set or reset; and
a data processor configured, in response to the at least one connection-specific timer expiring, to detect a silence suppression interval and allocate a minimum amount of periodic resources for the associated connection.

24. The electronic device of claim 23, wherein the data processor is further configured, in response to the receiver receiving an uplink frame, to allocate a specified amount of resource.

25. The electronic device of claim 24, wherein the specified amount of resources comprises a determined amount that fulfills requirements of a majority of connections.

26. The electronic device of claim 24, wherein the specified amount is predefined by a service provider.

27. The electronic device of claim 23, wherein the minimum amount of periodic resources comprises a minimum amount needed to send a request for additional resources.

28. The electronic device of claim 23, wherein the electronic device comprises a component in a worldwide interoperability for microwave access (WiMAX, IEEE 802.16 standard) system.

29. The electronic device of claim 28, wherein the electronic device utilizes an extended real-time polling service (ertPS).

30. The electronic device of claim 29, wherein the electronic device is configured to communicate utilizing voice over internet protocol (VoIP) with silence suppression.

31. The electronic device of claim 23, wherein the electronic device comprises a base station.

32. The electronic device of claim 23, wherein the data processor is further configured, in response to detecting the silence suppression interval, to store a previous resource allocation of the associated connection.

33. The electronic device of claim 32, wherein the data processor is further configured, in response to the receiver receiving an uplink frame from the associated connection after the silence suppression interval, to utilize the previous resource allocation for the associated connection.
